(19) United States
(12) Patent Application Publication
(10) Pub. No.: US 2026/0091960 A1
(43) Pub. Date: Apr. 2, 2026

(54) PORTABLE LIFTING CRANE

(71) Applicant: Elevall USA, LLC, Jupiter, FL (US)

(72) Inventor: Agustin Blasco Grau, Sueca (ES)

(21) Appl. No.: 19/377,962

(22) Filed: Nov. 3, 2025

Related U.S. Application Data
(63) Continuation-in-part of application No. PCT/ES2023/070503, filed on Aug. 4, 2023.

(51) Int. Cl. B66C 23/26; B66C 23/74; B66C 23/78

(52) U.S. Cl. CPC B66C 23/26; B66C 23/74; B66C 23/78

(57) ABSTRACT

A portable lifting crane that can be easily detached from a point of application for transport or storage and allows loads to be lifted to a considerable height. The portable lifting crane comprises a base, a roller and at least one diverter pulley of a lifting cable that lifts from the roller. The base is constructed and arranged to support a vertical mast, to which a side arm is coupled, the side arm may terminate in a diverter pulley. The arm may be horizontally oriented with respect to the base, characterized in that the base comprises a series of collapsible legs along an articulation with a vertical axis.

### REFERENCE TO RELATED APPLICATIONS

In accordance with 37 CFR 1.76, a claim of priority is included in an Application Data Sheet filed concurrently herewith. Accordingly, the present invention claims priority as a continuation-in-part application to International (PCT) Patent Application No. PCT/ES2023/070503, entitled “FOLDING LIFTING CRANE”, filed on Aug. 4, 2023, the contents of which are incorporated herein by reference in its entirety.

### FIELD OF THE INVENTION

The present invention relates to a device for lifting or moving objects; to a lifting crane for lifting bulky materials in the construction or remodeling of buildings; and more particularly to easily portable or dismountable lifting cranes that allow lifting loads to a considerable height.

### BACKGROUND OF THE INVENTION

Cranes for lifting loads to elevated levels are known in the state of the art. Some cranes are located on the ground and include tall, often telescopic, crane arms, and are limited in height to the length of the arm. Other crane types are raised to the working height, allowing loads to be raised to that height or lowered from there. Gantry cranes or other cranes that have a large, fixed structure and can rotate or move to move the load are known in the art. Such cranes are extremely bulky and are limited to where they can be placed and can be difficult in transporting. These types of cranes require a sturdy floor, a wide access path, and a long installation time are required.

### SUMMARY OF THE INVENTION

The invention consists of a portable lifting crane designed to be placed at a height, for example on the floor of a building where a load is to be transported or removed. In certain embodiments, the portable lifting crane may be small in size and easily foldable or disassembled.

In one embodiment, the lifting crane comprises a base from which a vertical mast and a lateral arm emerge. At the free end of the arm there is a pulley for diverting a hoisting cable. A roller takes up the cable when required, for example by using a motor. The arm can be oriented horizontally and can rotate on a vertical axis, for example, by making the mast rotate on the base. The base has folding legs, for which they are joined to the base by means of a vertical axis joint (parallel to the mast). In addition, the legs can be telescopic. The legs preferably have threaded bushings with height adjusters for the stabilizers, which are made of rubber and have a radius of at least 3 cm.

In another embodiment, the lifting crane in certain embodiments, the lifting crane may comprise a base from which a round vertical mast emerges, inside which is a telescopic tube serving as a strut that can be extended by a winch to support itself against a building's roof, or by using its attic accessory using braces and counterweights to prevent it from tipping over, and a lateral arm that is also extendable in length and has three tilt points. At a free end of the arm, the foldable lifting crane comprises a pulley with an electromechanical limit switch, making this a safe lifting system that prevents the hoist cable from slipping out.

A drum or wheel retracts the cable when desired, such as by use of a hoist-type motor, usually electric, and with a frequency inverter for smooth lifting and stopping, avoiding sudden shocks during handling. The arm can be horizontally oriented, allowing it to rotate around a vertical axis. This can be accomplished by making the mast rotatable on the base.

The foldable lifting crane is designed to be highly stable, and therefore include: ballasts, extendable stabilizing legs at the bottom, which in the design are folded into the machine for easy transport. The mast may include an upper extension or strut extendable by a manual winch, topped with extendable stabilizing members oriented upward in the shape of a cross with distances calculated to withstand any load within the tests performed. Welded onto these are threaded legs that press against a roof, in turn exerting pressure against the ground, making it impossible for the machine to tip over. The extendable members may extend perpendicular to the mast to increase the distance of the stabilizing moment.

Accordingly, it is an objective of the invention to provide an improved lifting crane for lifting bulky or heavy materials.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a side view of an illustrative embodiment of a portable, foldable lifting crane;

FIG. 2 is a top view of portable, foldable lifting crane shown in FIG. 1;

FIG. 3 is a side view of an alternative embodiment of the portable, foldable lifting crane, shown with an extendable ceiling anchor;

FIG. 4 is an alternative view of the portable, foldable lifting crane illustrated in FIG. 3, showing the lower part of the mast for attic installations with counterweight accessory and braces;

FIG. 5 is a top view of the portable, foldable lifting crane in FIG. 3;

FIG. 6 illustrates a pulley pin; and

FIG. 7 is a partial view of the portable, foldable lifting crane illustrated in FIG. 3.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

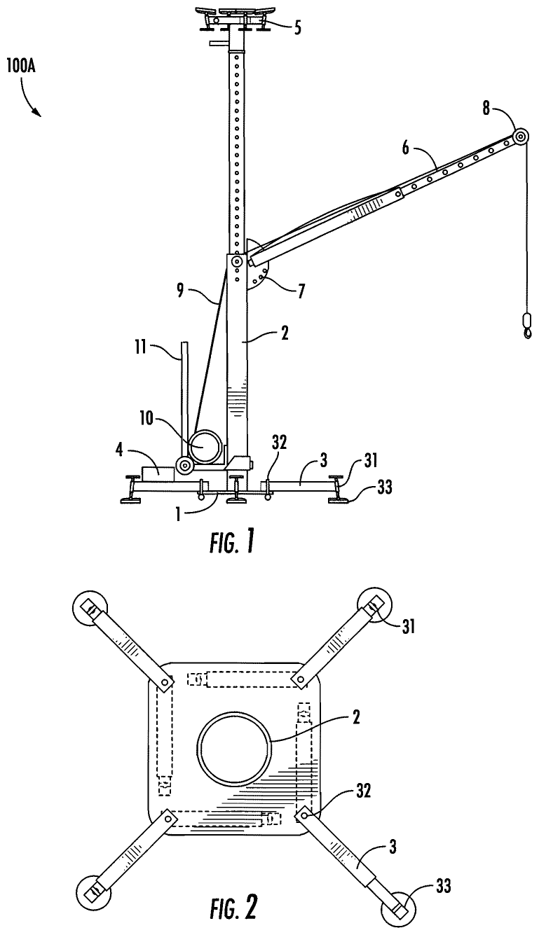

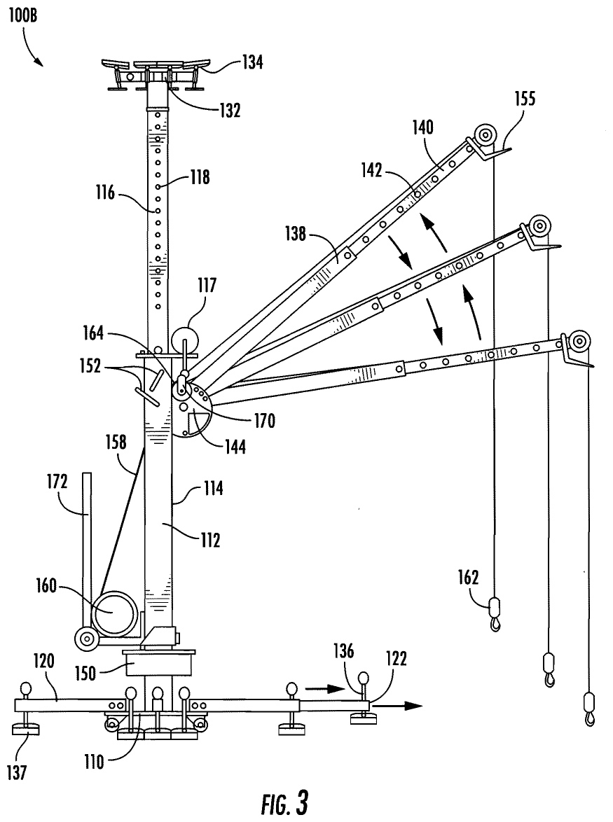

Referring generally to FIGS. 1-7, embodiments of a foldable lifting crane are provided. Referring specifically to FIG. 1 and FIG. 2, an example of a foldable lifting crane, referred to generally as foldable lifting crane 100A, is shown. The foldable lifting crane 100A comprises a base (1) that supports a vertical mast (2). The mast (2) may be round or square in section and extendable. The base (1) includes stabilizing legs (3). In the FIG. 1, the base (1) has ballasts (4) arranged in couplings made in some legs (3). These ballasts (4) can be replaced by other mechanisms. For example, the mast (2) can have an upper extension (5) supported by pressure against the ceiling of the floor where the foldable lifting crane 100A is installed. This upper extension (5) can in turn have extendable stabilizing members. A lateral arm (6) emerges from the mast (2), adjustable in angle, from a support (7).

The legs (3) have threaded, inclined sockets (31) with height adjusters for the stabilizers (33) that contact the ground. The legs (3) are connected to the base (1) by a joint (32) with a vertical axis, so that they can be folded down on the base (1), moving closer to the mast (2) to reduce the space they occupy (FIG. 2). Legs (3) may be telescopic. The stabilizers (33) are large (at least 3 cm radius) and made of rubber to prevent slipping.

At a free end of the arm (6) there is a bypass pulley (8) for the passage of a cable (9) which is guided along the arm (6) and the mast (2) to a wheel or roller (10) for collecting a cable (9). The cable (9) ends in a hook or fixing for the load. The foldable lifting crane 100A may have other bypass pulleys (8). The roller (10) may be motorized, controlled by a remote control to increase safety and allow the user who places the load on the cable to control the roller (10) and verify that the load follows the intended path without hitting any object. On the mast (2), the roller (10) may be supported by a shelf (11) which can be removed from the mast (2). The attachment of the shelf (11) can be used for the connection of removable transport wheels.

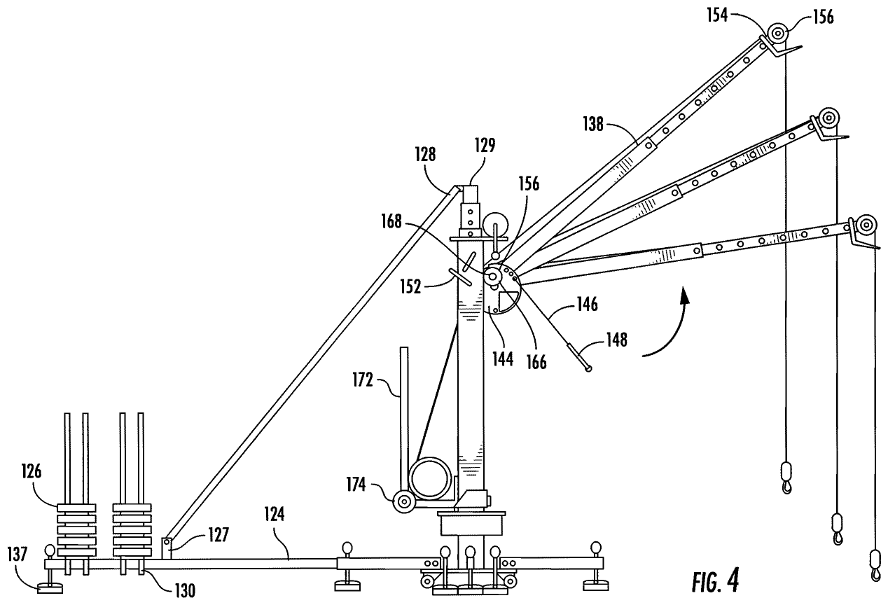

Referring to FIGS. 3-7, an alternative portable, foldable lifting crane, referred to generally as foldable lifting crane 100B, is shown. The foldable lifting crane 100B is designed to be placed at a height, for example on the floor or attic of a building where the load is to be transported, or from where it is to be removed. In certain embodiments, the foldable lifting crane 100B is configured to be easily foldable or disassembled and can be transported by a single person.

As shown in FIG. 3, the foldable lifting crane 100B comprises a base 110, illustrated herein as a generally flat plate or structure, configured to support the vertical mast 112. The vertical mast 112 is shown as a vertically orientated, elongated body 114 extending upwardly, away from the base 110. In certain embodiments, the vertical mast 112 may be round. The vertical mast 112 may contain an interior sized and shaped to receive and hold an inner, extending structure 116, illustrated herein as an inner tube. The inner, extending structure 116 may comprise openings 118, designed to hold a securing emmer such as a pin 119 (see FIG. 7), this allowing for the inner, extending structure 116 (also referred to as a mast upper extension member or strut) to be fixed as it is height adjusted. As such, the inner extending structure 116 serves as an extendable strut. In one embodiment, the mast 112 upper extension or strut 116 may be extendable by a manual winch 117, topped with extendable stabilizing members 132 oriented upward in the shape of a cross with distances calculated to withstand any load within the tests performed.

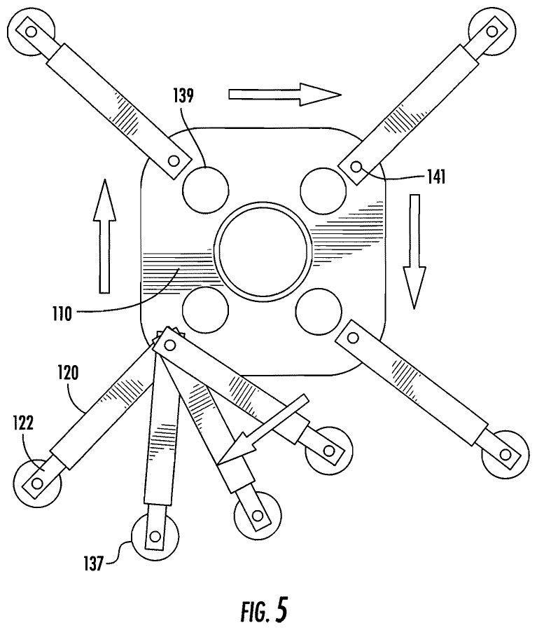

The base 110 optionally may include wheels secured to the underneath of the base 110. As illustrated in FIG. 4, the base 110 may also include accessory legs 124 for installing ballasts 126, such as weights or weighted objects, with support braces 128 (shown as a tie rod secured to a coupling member 127) and upper support member 129, arranged in a housing 130 placed or secured within some of the accessory legs 124. The ballasts 126 may be securely fixed to the accessory legs 124 through couplings 130 when necessary. In alternative embodiments, ballasts 126 may be replaced by other mechanisms. For example, the mast 112 may include an upper extension 132. The upper extension 132 may be held by pressure against a ceiling of a floor where it is located/being used. Once the foldable lifting crane 100B is installed, the upper extension 132 may utilize one or more extendable stabilizing members 134.

The legs 120 may be configured to have threaded, inclined bushings 136 with height adjustable feet 137. The height adjustable feet 137 may include a ball joint having a threaded stud to support the foldable lifting crane 100B on the ground when pressure is exerted, preventing the foldable lifting crane 100B from sinking in the center part, thus providing strength and safety. The legs 120 are designed to be rotatable and/or foldable according to articulation of a vertical axis (see 141, FIG. 5).

Additionally, the base 110 may include internal stabilizers 139 (FIG. 5). The internal stabilizers 139 may be the same as or similar to the feet 137, in that the stabilizers 139 are height adjustable and may include a ball joint having a threaded stud to support the foldable lifting crane 100B on the ground when pressure is exerted, preventing the foldable lifting crane 100B sinking in the center part, thus providing strength and safety. The stabilizers 139 may be designed to provide anti-vibration to increase safety.

The foldable lifting crane 100B comprises a lateral arm 138, attached to and extending from the mast 112. The lateral arm 138 may contain an interior sized and shaped to receive and hold a telescoping second arm 140. The telescoping second arm member 140 may comprise openings 142, designed to hold a securing member, such as a pin, this allowing for the telescoping second arm member 140 to be fixed in various positions as it is length adjusted. The lateral arm 138 may be attached to the mast 112 by two plates 144 with holes 146, such that a series of removable pins 148 secure it in one of its three positions at the desired angle (see FIG. 4). The lateral arm 138 may be oriented in any horizontal direction (relative to the base or ground), either by being mounted on a rotating bracket 150 on the fixed mast 110 or because the mast 110 itself may be configured to rotate on the base 110. The lateral arm 138 may be rotatable or pivoted to assume various tilt angles, such but not limited to 12 degrees, 30 degrees, 45 degrees from the mast 112, thus providing arm positing capabilities in various positions.

The mast 110 may include lever brakes 152 to prevent rotation during lifting. The (double) lever brakes 152 provide safety by anchoring the arms 138 rotation at two points. It is typically utilized when performing a lifting operation and is released when the material lifted is at the top.

At a free end 154 of the lateral arm 138 is a shunt or diverting pulley 156 for the passage of a cable 158. The cable 158 is guided along the lateral arm 138 and the mast 110 by a wheel or roller 160 for collecting the cable 158. The ends of the cable 158 ends in a load attachment 162, illustrated herein as a hook. Additional shunt pulleys 164 may be used. The free end 154 of the lateral arm 138 may also include an electromechanical limit switch 155.

The roller 160 is designed to orient itself at the same time as the arm lateral arm 138 and is generally located on the side of the mast 110 opposite the lateral arm 138. The roller 160 may be motorized and may be controlled using a control panel (for example, controlled by a frequency inverter with soft start-stop). This roller 160 can be controlled remotely for increased safety. In certain embodiments, the rotation of the lateral arm 138 and/or the mast 110 may be motorized and controlled remotely as well.

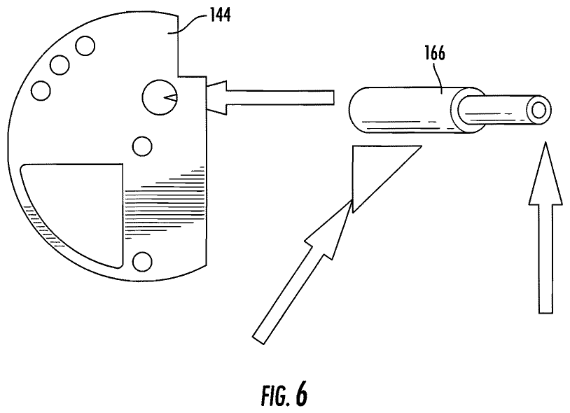

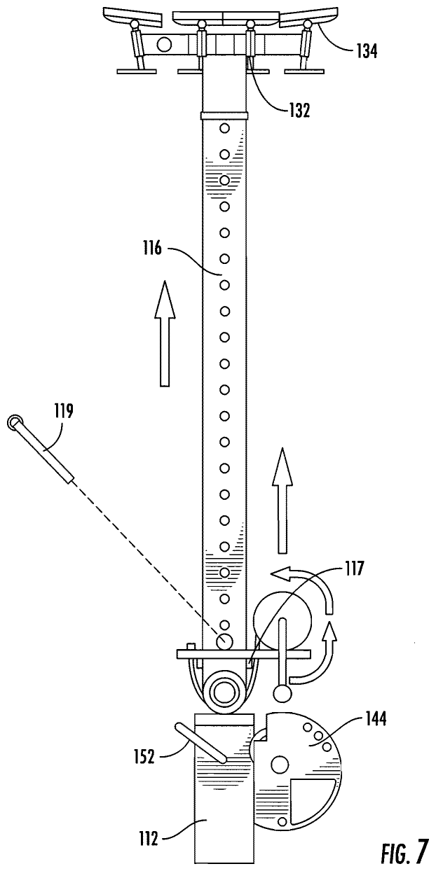

The base 110 may include ring system (a bearing positioned where the rotating mast 112 rest on a support) for attaching the rotating mast 110, ensuring that it cannot be accidentally dislodged or removed by means of studs passed through the round mast welded to the base 110. A bolt 166 (FIG. 6) is welded to the top of the mast 112 (FIG. 4) with plate reinforcements 168. The bolt 166 may be machined to accommodate the pulley and includes a thread in the center where the cable guard and pulley stop 170 are screwed, which is a physical protection system to prevent the cable 158 from jumping or accidentally coming off the pulley. In a certain embodiment, the mast 112 is rotatable as a whole, and the roller 160 is supported by it by a shelf or transport cart 172 with wheels 174 removable from the mast 112.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A lifting crane for lifting materials comprising:
a base, said base comprising a plurality of legs and being height adjustable by height adjustable feet;
a mast secured to said base, said mast having an elongated body extending upwardly in a vertical direction from said base and an upper extension member movably engaged with said mast elongated body;
a later arm attached to said mast, said arm comprising a telescoping second arm member movably engaged with an interior of said lateral arm, a shunt or diverting pulley with an electromechanical limit switch positioned at an end, said later arm oriented horizontally relative to said base

2. The lifting crane according to claim 1, wherein said mast rotates on said base.

3. The lifting crane according to claim 1, wherein said upper extension member is movably engaged with an interior of said mast elongated body, said upper extension member being operatively connected to a winch.

4. The lifting crane according to claim 3, wherein said upper extension member terminates in a stabilizing member.

5. The lifting crane according to claim 1, wherein said base comprises a leg extension member.

6. The lifting crane according to claim 1, further including a counter weight system comprising a ballast placed within a ballast housing, a support brace, and an upper support member.

7. The lifting crane according to claim 1, further including a roller.

8. The lifting crane according to claim 1, wherein said roller is motorized.

9. The lifting crane according to claim 1, wherein said roller is mounted on a removable shelf.

10. The lifting crane according to claim 1, wherein said arm is secured to said mast by two plates.

11. The lifting crane according to claim 1, wherein said mast includes lever brakes.

12. The lifting crane according to claim 7, wherein said roller is located on a side of said mast opposite said lateral arm.
